(19) United States
(12) Patent Application Publication
(10) Pub. No.: US 2013/0227422 A1
(43) Pub. Date: Aug. 29, 2013

(54) ENTERPRISE PORTAL SMART WORKLIST

(71) Applicants: Doron Lehmann, Kfar Vradim (IL); Nimrod Barak, Tel Aviv (IL)

(72) Inventors: Doron Lehmann, Kfar Vradim (IL); Nimrod Barak, Tel Aviv (IL)

(73) Assignee: SAP Portals Israel Ltd., Raanana (IL)

(21) Appl. No.: 13/407,059

(22) Filed: Feb. 28, 2012

(51) Int. Cl. G06F 3/01; G06F 15/16

(52) U.S. Cl. 715/738

(57) ABSTRACT

The disclosure generally describes computer-implemented methods, software, and systems optimizing enterprise portal smart worklists. A computer-implemented method includes receiving a navigation request by a user for an enterprise portal page associated with a navigation node view of a navigation node, receiving at least one user action associated with the enterprise portal page, determining, using at least one computer, whether the at least one user action is substantive, determining whether multiple navigation requests for the enterprise portal page have been made by the user, and determining whether the navigation request is associated with a collaborative group.

### TECHNICAL FIELD

The present disclosure relates to computer-implemented methods, software, and systems for optimizing enterprise portal smart worklists.

### BACKGROUND

Content is distributed throughout an enterprise portal. Accessing content often requires a user to perform several navigations. A user may remember how to navigate to content or manually add the desired content path to a “favorites” mechanism for faster access to specific content. Remembering a content navigation path is inefficient, saving favorite paths require manual effort, and a content path may change rendering memorized navigation paths and favorites invalid.

### SUMMARY

The disclosure generally describes computer-implemented methods, software, and systems for optimizing enterprise portal smart worklists. A computer-implemented method receives a navigation request by a user for an enterprise portal page associated with a navigation node view of a navigation node. At least one user action associated with the enterprise portal page is received and a determination is made whether the received user action is substantive. A determination is then made whether multiple navigation requests for the enterprise portal page have been made by the user and whether the navigation request is associated with a collaborative group.

The present disclosure relates to computer-implemented methods, software, and systems for optimizing enterprise portal smart worklists. One computer-implemented method includes: receiving a navigation request by a user for an enterprise portal page associated with a navigation node view of a navigation node, receiving at least one user action associated with the enterprise portal page, determining, using at least one computer, whether the at least one user action is substantive, determining whether multiple navigation requests for the enterprise portal page have been made by the user, and determining whether the navigation request is associated with a collaborative group.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In particular, one implementation can include all the following features:

In a first aspect combinable with any of the previous aspects, the navigation request is associated with a particular computing platform.

In a second aspect combinable with any of the previous aspects, the at least one user action includes at least one of selection of a GUI component, data entry, data modification, data deletion, or generating a report.

In a third aspect combinable with any of the previous aspects, the determination of whether the at least one user action is substantive is based upon substantive determination criteria.

In a fourth aspect combinable with any of the previous aspects, the substantive determination criteria includes at least one of a number of navigation requests to the enterprise portal page, an enterprise portal page landing time, an interaction with the enterprise portal page, or events triggered by the user.

In a fifth aspect combinable with any of the previous aspects, the method of claim 1 further comprises: modifying a smart worklist of the user, sorting the smart worklist of the user, and performing a secondary modification of the smart worklist of the user.

In a sixth aspect combinable with any of the previous aspects, the method of claim 1 further comprises: modifying a smart worklist of the user and at least one collaborative user collaborating with the user as part of the collaborative group, sorting the smart worklists of the user and the at least one collaborative user, and performing a secondary modification the smart worklists of the user and the at least one collaborative user.

The subject matter described in this specification can be implemented in particular implementations so as to realize one or more of the following advantages. First, a smart worklist can be automatically generated listing a navigated-to enterprise portal page based upon a user's actions on the enterprise portal page. Second, a smart worklist can be automatically generated listing a navigated-to enterprise portal page based upon other users' actions on the enterprise portal page. Third, the generated smart worklist is of stable links to enterprise portal pages. Fourth, individual smart worklists may be generated based upon different computing platforms, such as mobile, desktop, cloud-computing, geographically situated, etc. Fifth, presented smart worklist entries can be prioritized and/or optimized according to various criteria. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example system for optimizing enterprise portal smart worklists.

FIG. 2 is a block diagram illustrating an example enterprise portal page with an empty smart worklist.

FIG. 3 is a block diagram illustrating an example enterprise portal page with an updated smart worklist.

FIG. 4 is a block diagram illustrating an example enterprise portal page with an divided smart worklist.

FIG. 5 is a flowchart of an example method for optimizing enterprise portal smart worklists.

Like reference numbers and designations in the various drawings indicate like elements.

### DETAILED DESCRIPTION

The disclosure generally describes computer-implemented methods, software, and systems for optimizing enterprise portal smart worklists. For the purposes of this disclosure, an enterprise portal, also known as an enterprise information portal (EIP) or a corporate portal, is a framework for integrating information, people, and processes across organizational boundaries. The enterprise portal provides a secure unified access point, often in the form of a Web-based user interface, and is designed to aggregate and personalize information through application-specific portals. The enterprise portal is the de-centralized content contribution and content management system, which keeps the information always updated. With only a Web browser, users can begin work once they have been authenticated in the portal which offers a single point of access to information, enterprise applications, and services both inside and outside an organization. Portals may present information from diverse sources in a unified and structured way, and provide additional services, such as dashboards, an internal search engine, e-mail, news, enterprise portal navigation tools, and various other features. Portals are often used by enterprises for providing their employees, customers, and possibly additional users with a consistent look and feel, and access control and procedures for multiple applications, which otherwise would have been separate entities altogether.

For the purposes of this disclosure, a business object can be considered a representation of a business entity, such as an employee, a sales order, an invoice, a financial report, etc. The business object may encompass both functions, for example in the form of methods, and data, such as one or more properties. For example, business objects may reduce system complexity by reducing a system into smaller units. The implementation details of business objects are typically hidden from a non-development user and may be accessed through the defined functions and encapsulated data. Business objects also form a point of entry of the functions and data of a system and enable the system to easily share, communicate, display, or otherwise operate with other systems.

Generally, through a graphical user interface (GUI), an enterprise portal user is provided with an efficient and user-friendly presentation of data provided by or communicated within the system. The term “graphical user interface,” or GUI, may be used in the singular or the plural to describe one or more graphical user interfaces and each of the displays of a particular graphical user interface. Therefore, a GUI may represent any graphical user interface, including but not limited to, a Web browser, a touch screen, or a command line interface (CLI) that processes information and efficiently presents the information results to the user. In general, GUI may include a plurality of user interface (UI) elements, some or all associated with a Web browser, such as interactive fields, pull-down lists, and buttons operable by the enterprise portal user. These and other UI elements may be related to or represent the functions of the Web browser.

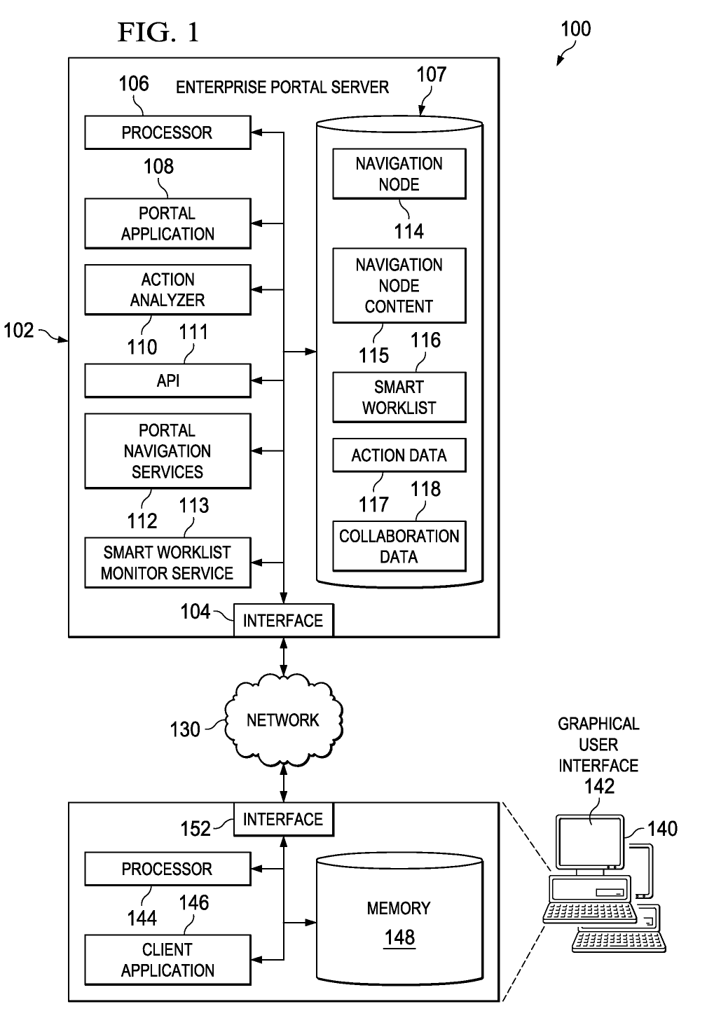

FIG. 1 illustrates an example distributed computing system 100 operable to optimize enterprise portal searching. Specifically, the illustrated environment 100 includes or is communicably coupled with an enterprise portal server 102, a client 140, and an external search engine that communicate across a network 130.

In general, the enterprise portal server 102 is a server that stores one or more portal applications 108, where at least a portion of the portal applications 108 are executed via requests and responses sent to users or clients within and communicably coupled to the illustrated environment 100 of FIG. 1. In some implementations, the enterprise portal server 102 may store a plurality of various portal applications 108. In other implementations, the enterprise portal server 102 may be a dedicated server meant to store and execute only a single portal application 108. In some implementations, the enterprise portal server 102 may comprise a Web server, where the portal applications 108 represent one or more Web-based applications accessed and executed by the client 140 via the network 130 or directly at the enterprise portal server 102 to perform the programmed tasks or operations of the portal application 108.

At a high level, the enterprise portal server 102 comprises an electronic computing device operable to receive, transmit, process, store, or manage data and information associated with the environment 100. Specifically, the enterprise portal server 102 illustrated in FIG. 1 is responsible for receiving application requests, for example enterprise portal navigation requests, from one or more client applications associated with the client 140 of the environment 100 and responding to the received requests by processing said requests in the associated portal application 108, and sending the appropriate response from the portal application 108 back to the requesting client application 146. In addition to requests from the client 140, requests associated with the portal applications may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates a single enterprise portal server 102, environment 100 can be implemented using two or more servers 102, as well as computers other than servers, including a server pool. Indeed, enterprise portal server 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated enterprise portal server 102 may be adapted to execute any operating system, including Linux, UNIX, Windows, Mac OS, Java, Android, iOS or any other suitable operating system. According to one implementation, enterprise portal server 102 may also include or be communicably coupled with an e-mail server, a Web server, a caching server, a streaming data server, and/or other suitable server.

The enterprise portal server 102 also includes an interface 104, a processor 106, and a memory 107. The interface 104 is used by the enterprise portal server 102 for communicating with other systems in a distributed environment—including within the environment 100—connected to the network 130; for example, the client 140, as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated environment 100.

As illustrated in FIG. 1, the enterprise portal server 102 includes a processor 106. Although illustrated as a single processor 106 in FIG. 1, two or more processors may be used according to particular needs, desires, or particular implementations of the environment 100. Each processor 106 may be a central processing unit (CPU), a blade, an application specific integrated circuit (ASIC), a field-programmable gate array (FPGA), or another suitable component. Generally, the processor 106 executes instructions and manipulates data to perform the operations of the enterprise portal server 102. Specifically, the processor 106 executes the functionality required to receive and respond to requests from the client 140 and/or perform smart worklist optimization functionality.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java, Visual Basic, assembler, Perl, any suitable version of 4GL, as well as others. While portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

The enterprise portal server 102 also includes a memory 107, or multiple memories 107. The memory 107 may include any type of memory or database module and may take the form of volatile and/or non-volatile memory including, without limitation, magnetic media, optical media, random access memory (RAM), read-only memory (ROM), removable media, or any other suitable local or remote memory component. The memory 107 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the enterprise portal server 102. Additionally, the memory 107 may include any other appropriate data, such as VPN applications, firmware logs and policies, firewall policies, a security or access log, print or other reporting files, as well as others.

The enterprise portal server 102 further includes an application programming interface (API) 111. The API 111 may include specifications for routines, data structures, and object classes. The API 111 may be either computer language independent or dependent and refer to a complete interface, a single function, or even a set of APIs. In some implementations, the API 111 can be used to interface between the portal application 108, portal navigation services 112, smart worklist monitor service 113, and/or other system components, both hardware and software. For example, in one implementation, the portal application 108 can utilize API 111 to communicate with the portal navigation services 112 and/or smart worklist monitor service 113 during enterprise portal navigation.

The memory 107 includes a navigation node 114, navigation node content 115, worklist data 116, action data 117, and collaboration data 118. Although illustrated as single instances, there may be more than one instance of the navigation node 114, the navigation node content 115, the worklist data 116, the action data 117, and/or the collaboration data 118.

The navigation node 114 can be considered the target of a request for data in an enterprise portal, for example an enterprise portal page, a Web page, or the final destination of a navigation action, etc. A navigation node 114 contains the view to be displayed when the navigation node is accessed. In some implementations, the navigation node 114 can control the location of a selected view, personalized views for a specific enterprise portal user, and dynamic views. In some implementations, a navigation node 114 may be considered a business object. Each navigation node 114 in the enterprise portal also contains metadata regarding the displayed data, for example sales, revenue, reporting, customers, user role, etc. This metadata may be used to determine the context of a particular displayed view. For the purposes of this disclosure, a navigation node 114 view and an enterprise portal page may be used interchangeably.

The navigation node content 115 is the textual, visual or aural content that is encountered as part of the user experience when accessing a navigation node 114 within an enterprise portal. The navigation node content 115 may include, among other things: text, images, sounds, videos and animations. While illustrated as integrated with memory 107 of the enterprise portal server in the example environment 100 of FIG. 1, in alternative implementations, the navigation node content 115 source can be external to the enterprise portal server 102 and/or from the example environment 100 or internal to the navigation node 114.

The enterprise portal server 102 further includes portal navigation services 112. Generally, the portal navigation services 112 are responsible for the creation of the content hierarchy in the portal, and to provide access to all of the additional services provided in the “shell” of the portal (e.g., searching capabilities, personalization, modification, deletion, etc.). For example, the navigation services 112 may create a tree of navigation nodes for each enterprise portal user who enters the portal. In addition to that discussed above, each navigation node 114 represents specific content, or a collection of content, that may be viewed by the enterprise portal user. In some implementations, the content can be specifically tailored for each enterprise portal user. For enterprise portal user, the portal navigation services 112 are responsible for generating a navigation tree of links to the portal content assigned to the user. An application—for example, a client running on a user's machine or an application running in the enterprise portal—may query the navigation services 112 for the current user's navigation hierarchy or tree, and then display this tree to the user. In some implementations, portal applications 108 can communicate with the navigation services 112 directly and/or via API 111. In some implementations, internal/external services, software, and/or other components, including those not illustrated, can communicate with the navigation services 112 directly and/or via the API 111.

The illustrated enterprise portal server 102 further includes a smart worklist monitor service 113 that generates and updates one or more smart worklists 116. The smart worklist monitor service 113 may be part of a backend service layer (not illustrated) providing software services to example environment 100. The business functionality of the enterprise portal system may be accessible for all service consumers via this service layer. The software services, such as the smart worklist monitor service 113, provide reusable, defined business functionalities through a defined interface. For example, the interface may be software written in extensible markup language (XML) or other suitable language. The backend service layer may be integrated with one or more components of example environment 100. Moreover, any or all parts of the backend service layer may be implemented as child or sub-modules of another software module or enterprise application (not illustrated) or of another hardware module (not illustrated) without departing from the scope of this disclosure. In some implementations, the smart worklist monitor service 113 operates in real-time. In other implementations, the smart worklist monitor service 113 is triggered by the action(s) of some other software or hardware component(s), for example an enterprise portal user's request on a GUI to navigate to a particular navigation node 114 or to view particular navigation node content 115 associated with the particular navigation node 114. In other implementations, the smart worklist monitor service 113 can automatically disable itself due to some determined criteria, such as a timeout, a specific user action, etc. In some implementations, the smart worklist monitor service 113 can be manually disabled and/or manually re-enabled.

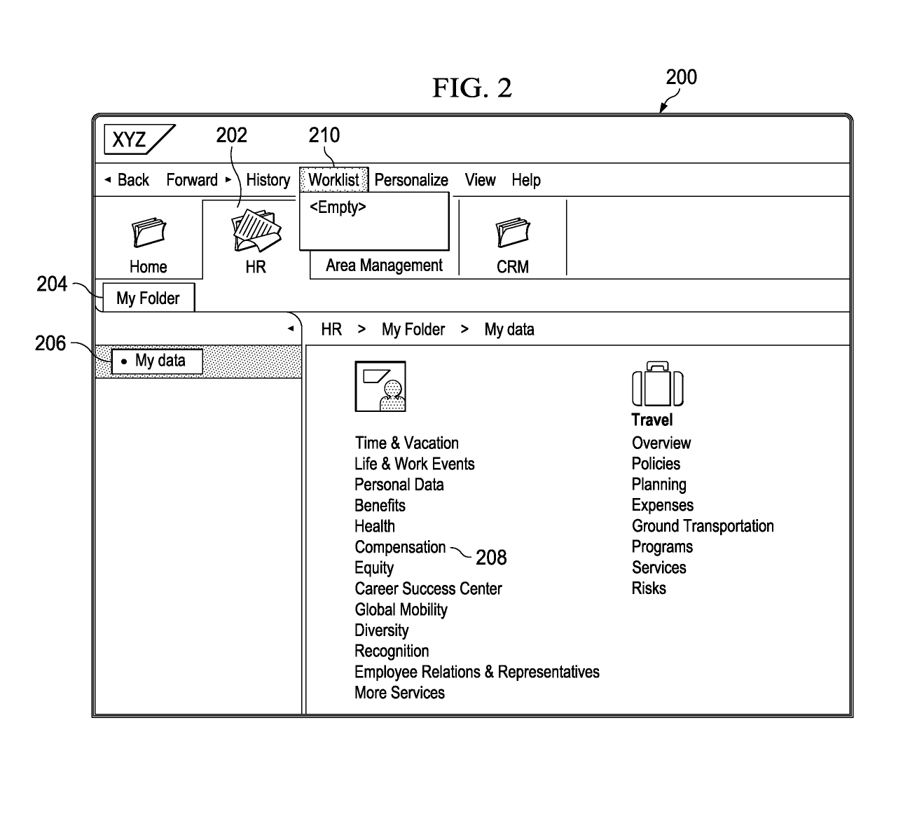

A smart worklist 116 provides an enterprise portal user with a mechanism to add desired and relevant pages to a stable list of pages to enhance, among other things, the speed, accuracy, and relevance of navigation tasks within the enterprise portal system. Content is distributed throughout an enterprise portal system and a user may be required to perform several navigations to access the user's desired content. Turning now to FIG. 2, FIG. 2 is a block diagram illustrating an example “My data” enterprise portal page 200. For example, the enterprise portal user seeking their compensation data on the enterprise portal may navigate to an HR tab 202, select a “My Folder” folder 204, then select a “My Data” link 206, and finally select a “Compensation” navigation link 208 to access the “Compensation” page to access the desired content. The smart worklist 116 may be displayed by a GUI and/or a component of a GUI. For example, the smart worklist 116 can be displayed by a pull-down menu on an enterprise portal page within a Web browser. The Web browser may display one or more navigation links selectable by an enterprise portal user. For example, an example smart worklist 116 is shown accessed through a “Worklist” GUI menu 210. Note that the smart worklist 116 is indicated as empty as the smart worklist monitor service 113 has not added any navigation links to the smart worklist 116 associated with the enterprise portal user. Returning now to FIG. 1, the smart worklist 116 and associated functionality is considered “smart” because adding, modifying and/or deleting a relevant page reference to the smart worklist 116 may be both seamless and automatic for the enterprise portal user based upon the enterprise portal user or other enterprise portal user's actions, navigation links added to the smart worklist 116 remain stable, separate smart worklists 116 may be generated depending on the computing platform used to access the enterprise portal, and the smart worklist 116 may be prioritized and/or optimized to enhance usability for the enterprise portal user. In some implementations, the smart worklist 116 may be a database file, a text file, binary data, or other suitable data structure.

Returning now to FIG. 1, the smart worklist monitor service 113 may perform various functions in order to optimize enterprise portal smart worklists 116. First, the smart worklist monitor service 113 adds desired and relevant pages to a particular enterprise portal user's smart worklist 116 based upon the enterprise portal user's actions. Actions may be, for example, selection of GUI items on the particular enterprise portal page, data entry, selection of hyperlinks on the particular enterprise portal page, or other suitable actions. In some implementations, substantive actions are necessary in order to update a smart worklist 116 following navigation to an enterprise portal page. Whether an action is substantive may be based upon criteria such as the number of navigation requests to the enterprise portal page, a page landing time (i.e., how long the enterprise portal user was at the enterprise portal page), interaction with the enterprise portal page (e.g., data entry, watching a video, requesting a report generation, etc.), events that are triggered by the enterprise portal user (e.g., GUI menu items were selected, values were changed, etc.). For example, simply navigating to an enterprise portal page and then immediately navigating to another enterprise portal page may not be considered substantive, but navigating to an enterprise portal page every days, generating a daily income report, and watching a daily company headquarters news video may be considered substantive actions. In some implementations, analysis of an enterprise portal user's actions and/or a determination as to whether they are substantive can be performed by an action analyzer 110. In some implementations, the action analyzer 110 can be a software and/or hardware module. In some implementations, the action analyzer 110 notifies the smart worklist monitor service of its analysis results. In some implementations, the action analyzer 110 can read/write action data and/or analysis data to action data 117.

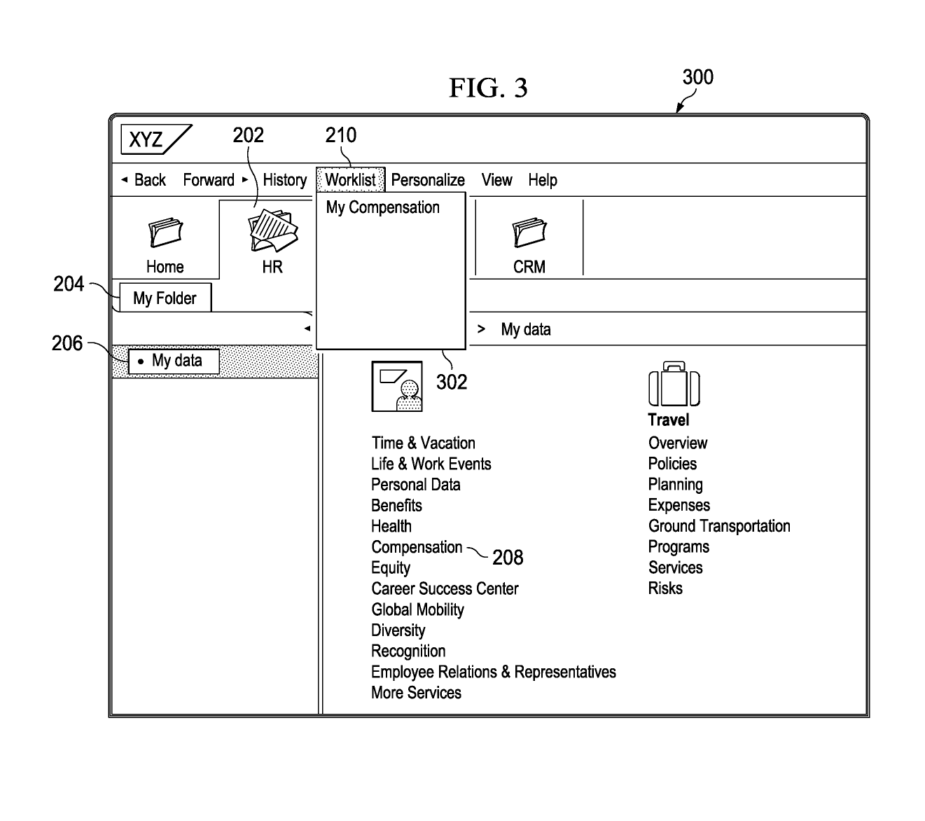

Upon determination by the smart worklist monitor service 113 that the enterprise portal user's navigation actions are substantive, the smart worklist 116 may be updated to reflect the navigation to the enterprise portal page. For example, turning now to FIG. 3, FIG. 3 is a block diagram illustrating an example enterprise portal page with an updated smart worklist 116. Consistent with the example illustrated by FIG. 2 above, a new navigation link 302 may be added to the smart worklist 116 accessed by selecting the GUI menu 210. The navigation link 302 is identified by a text string “My Compensation” and is selectable by an enterprise portal user. In some implementations, the smart worklist monitor service 113 selects the navigation link designators to be added to the smart worklist 116. In this example, the smart worklist monitor 113 selected a navigation link 302 text string identifier of “My Compensation.” In other implementations, the designator can be an image, an icon, a sub-menu item, or other suitable designator in a GUI. If the enterprise portal user selects the “My Compensation” navigation link 302 in the displayed smart worklist 116, the “Compensation” enterprise portal page associated with the enterprise portal user would be displayed as if the enterprise portal user had fully navigated as described above to the “My data” enterprise portal page 200 and then selected the Compensation navigation link 208. In this example two user actions would allow the enterprise portal user to access their compensation data as opposed to at least four actions to fully navigate to the Compensation navigation link 208 from the HR tab 202. In some implementations, navigation links may be any color and/or font. In some implementations, the navigation links can be animated to focus an enterprise portal user's attention on the navigation link. In some implementations, the navigation link may be non-selectable or not displayed if a particular navigation link is not applicable to a particular enterprise portal user. In some implementations, the smart worklist monitor service 113 can also remove entries from a smart worklist 116 based upon actions by an enterprise portal user.

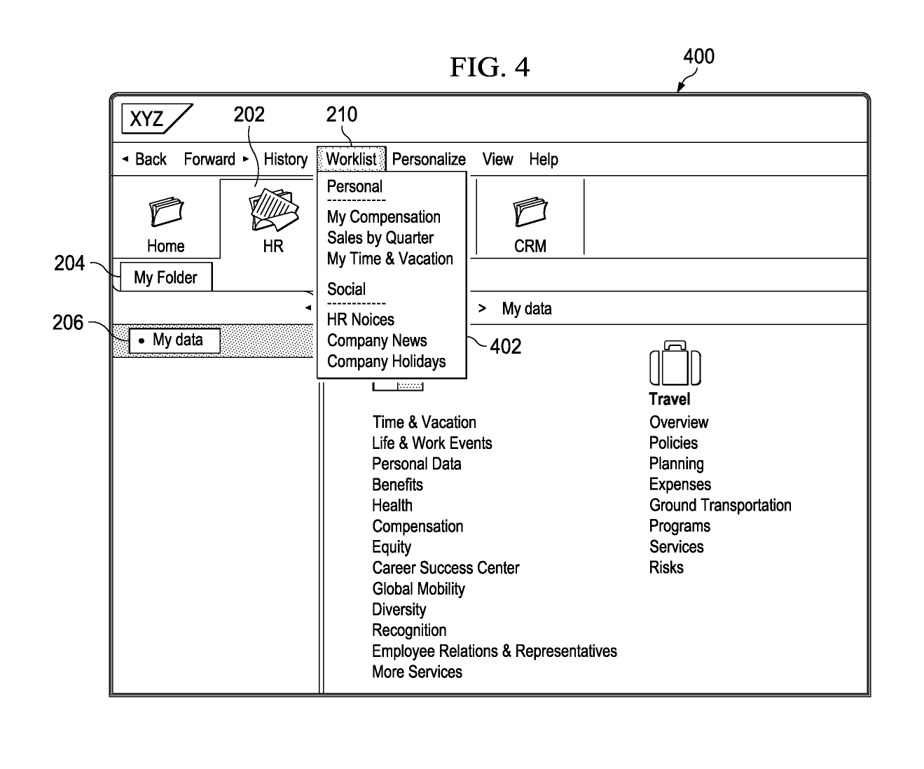

Second, the smart worklist monitor service 113 adds relevant pages to a particular enterprise portal user's smart worklist 116 based upon another related enterprise portal user's actions. In some implementations, other users' actions may affect a particular enterprise portal user's smart worklist 116 depending upon social interactive criteria determining some degree of relatedness. In some implementations, the social interactive criteria can include role, team, corporate group, collaborative actions, or other suitable criteria value. For example analysis by the action analyzer 110 of actions of software developers/testers working together collaboratively on software or a team manager that must review each team member several times weekly in the HR portion of the enterprise portal may trigger the smart worklist monitor service 113 to update one or more smart worklists 116. In the case of the software developers/testers, the collaborative efforts may be deemed of importance to all members of the collaborative team and their smart worklists 116 updated to reflect navigation links to, for example, software completion status, testing status, overall project plan, etc. In the case of the team manager, each individual team member's smart worklist 116 may be updated with a navigation link to the daily review for that team member. In some implementations, the smart worklist 116 may be divided into a personal worklist and a social worklist to reflect actions by the enterprise portal user and actions by other enterprise portal users. An example of a divided smart worklist 116 is illustrated in FIG. 4 at 402. In other implementations, the smart worklist 114 may be divided in any suitable manner. In some implementations, social interactive criteria indicating relatedness between enterprise portal users is not necessary for the actions of a first enterprise portal user to affect the smart worklist 116 of a second enterprise portal user. In some implementations, the smart worklist monitor service 113 can also remove entries from one or more smart worklists 116 based upon actions by enterprise portal users. In some implementations, the action analyzer 110 can read/write collaboration data and/or collaboration relationships to collaboration data 118.

Third, navigation links added to the smart worklist 116 remain exact and stable. Returning now to FIG. 1, in some implementations, the smart worklist 116 navigation links are references to a navigation node 114 which is used to render a view for an associated enterprise portal page. In some implementations, the reference can be a unique object name and/or identification value, such as a globally unique identifier (GUID), a result from a hash function, a checksum, or other suitable unique identification value. In these implementations, the navigation node 114 unique name and/or identification value does not change within the enterprise portal system regardless of what a Web browser URL might reflect for an enterprise portal page, thereby providing an exact and stable reference to access a particular navigation node 114 associated with an enterprise portal user. For example, an enterprise portal page URL may reflect “http://company.portal.com/HR/myFolder/myData/Compensation,” a URL that would be too abstract to be useful as a favorite, especially for other enterprise portal users. Even if this example URL were exact enough, it could change if, for example, the “My data” page name changed and the URL path was updated accordingly. Further, even if a URL property of the particular navigation node 114 were to change, a particular enterprise portal page view could still be rendered by referring to the particular navigation node 114's name and/or unique identification value and the URL updated by the enterprise portal user, the enterprise portal server 102, etc. As there is a unique name and/or identification value for a particular navigation node 114 associated with an enterprise portal user, multiple enterprise portal users are able to navigate to the same enterprise portal page simultaneously, but the navigation node 114 underlying the view generated to render the enterprise portal page may be unique to a specific enterprise portal user based upon different navigation node 114 property values, permissions, user role, etc.

Fourth, in some implementations, the smart worklist monitor service 113 can associate a contextual binding between an enterprise portal user's navigation to an enterprise portal page, that is a navigation node 114 view, and a specific computing platform accessing the enterprise portal. Separate smart worklists 116 can be generated depending on the computing platform used to access the enterprise portal page. For example, there may be a first smart worklist 116 associated with on-premise computers, a second smart worklist 116 associated with mobile devices, a third smart worklist data associated with cloud-based platform computers, etc. In these implementations, each of these separate smart worklists 116 can be independently managed by the smart worklist monitor service 113. In other implementations, the smart worklist 116 can be further personalized by various criteria to apply to an individual enterprise portal user. For example, the criteria may include user role, geographic location, accessing computing device identification, or other suitable criteria. In some implementations, the smart worklist monitor service 113 can optimize the smart worklist 116 for the particular attributes of a computing platform. For example, for a mobile computing platform, the smart worklist may have shorter navigation links or navigation links arranged in a manner to optimally fit within the confines of a mobile computing device display. Likewise, the worklist may be compressed for more efficient transmission across mobile networks. In some implementations, a user agent string associated with the mobile computing platform may be used to identify an enterprise portal user's mobile device, that is a client 140, to the enterprise portal server 102 and/or smart worklist monitor service 113. For example, the user agent profile string of the client application 146 with respect to the mobile device 140 can include:
Mozilla/5.0 (iPad; U; CPU OS 3_{—}2_{—}1 like Mac OS X; en-us)
AppleWebKit/531.21.10 (KHTML, like Gecko) Mobile/7B405
   This string identifies to the enterprise portal server 102 and/or the smart worklist monitor service 113 that at least the browser used is Mozilla 5.0 compliant, the mobile device is an Apple iPad™ running iOS v.3.2.1. The enterprise portal server 102 and/or the smart worklist monitor service 113 may then tailor content returned to the client 140 according to these specifications for optimum display to the enterprise portal user. In other implementations, other methods of identification can be used between a client 140 and the enterprise portal server 102 and/or the smart worklist monitor service 113. In other implementations, analysis of the user agent profile string can be performed by a user agent analyzer (not illustrated). The user agent analyzer can be part of the enterprise portal server 102, client 140, and/or another component (not illustrated) external to example environment 100.

Fifth, the smart worklist 116 may be prioritized and/or optimized to enhance usability for the enterprise portal user. In some implementations, the prioritization and optimization of the smart worklist 116 can be determined by a usage determination based upon usage criteria. The usage criteria may include the number of navigations to a specific enterprise portal page, actions performed on a specific enterprise portal page, the role of a particular enterprise portal user, or other suitable usage criteria. Actions may include a number and a type. For example once navigated to an enterprise portal page, a particular enterprise portal user viewed a video once and entered data into ten data fields. In some implementations, prioritizing the smart worklist 116 can include moving and/or placing certain navigation links in the smart worklist 116 to the top of the smart worklist 116, separating, highlighting, or somehow distinguishing specific navigation links from other navigation links, for example by bolding, color, animation, etc., or some other prioritization method. In some implementations, the usage determination is substantially continuous. In other implementations, the usage determination can be periodic or triggered by some system event, such as a user navigation or user action. In some implementations, other user's actions may also be prioritized. For example, if out of ten related enterprise portal users, six navigate to a first enterprise portal page and perform substantive actions and four navigate to a second enterprise portal page and perform substantive actions, in some implementations, a navigation link to the first page can be displayed first and a navigation link to the second page can be displayed second in the smart worklists 116 of the ten enterprise portal users.

The illustrated environment of FIG. 1 also includes the client 140, or multiple clients 140. The client 140 may be any computing device operable to connect to or communicate with at least the enterprise portal server 102 via the network 130 using a wireline or wireless connection. In general, the client 140 comprises an electronic computer device operable to receive, transmit, process, and store any appropriate data associated with the environment 100 of FIG. 1.

The illustrated client 140 further includes a client application 146. The client application 146 is any type of application that allows the client 140 to request and view content on the client 140. In some implementations, the client application 146 can be and/or include a Web browser. In some implementations, the client-application 146 can use parameters, metadata, and other information received at launch to access a particular set of data from the server 102. Once a particular client application 146 is launched, a user may interactively process a task, event, or other information associated with the server 102. Further, although illustrated as a single client application 146, the client application 146 may be implemented as multiple client applications in the client 140.

The illustrated client 140 further includes an interface 152, a processor 144, and a memory 148. The interface 152 is used by the client 140 for communicating with other systems in a distributed environment—including within the environment 100—connected to the network 130; for example, the enterprise portal server 102, as well as other systems communicably coupled to the network 130 (not illustrated). Generally, the interface 152 comprises logic encoded in software and/or hardware in a suitable combination and operable to communicate with the network 130. More specifically, the interface 152 may comprise software supporting one or more communication protocols associated with communications such that the network 130 or interface's hardware is operable to communicate physical signals within and outside of the illustrated environment 100.

As illustrated in FIG. 1, the client 140 includes a processor 144. Although illustrated as a single processor 144 in FIG. 1, two or more processors may be used according to particular needs, desires, or particular implementations of the environment 100. Each processor 144 may be a central processing unit (CPU), an application specific integrated circuit (ASIC), a field-programmable gate array (FPGA), or another suitable component. Generally, the processor 144 executes instructions and manipulates data to perform the operations of the client 140. Specifically, the processor 144 executes the functionality required to send requests to the enterprise portal server 102 and to receive and process responses from the enterprise portal server 102.

The illustrated client 140 also includes a memory 148, or multiple memories 148. The memory 148 may include any memory or database module and may take the form of volatile or non-volatile memory including, without limitation, magnetic media, optical media, random access memory (RAM), read-only memory (ROM), removable media, or any other suitable local or remote memory component. The memory 148 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client 140. Additionally, the memory 148 may include any other appropriate data, such as VPN applications, firmware logs and policies, firewall policies, a security or access log, print or other reporting files, as well as others.

There may be any number of clients 140 associated with, or external to, the environment 100. For example, while the illustrated environment 100 includes one client 140, alternative implementations of the environment 100 may include multiple clients 140 communicably coupled to the enterprise portal server 102 and/or the network 130, or any other number suitable to the purposes of the environment 100. Additionally, there may also be one or more additional clients 140 external to the illustrated portion of environment 100 that are capable of interacting with the environment 100 via the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the enterprise portal server 102 or the client 140 itself, including digital data, visual information, or a GUI 142, as shown with respect to the client 140.

Further, the illustrated client 140 includes the GUI 142. The GUI 142 interfaces with at least a portion of the environment 100 for any suitable purpose, including generating a visual representation of a Web browser. In particular, the GUI 142 may be used to view and navigate various Web pages located both internally and externally to the enterprise portal server 102.

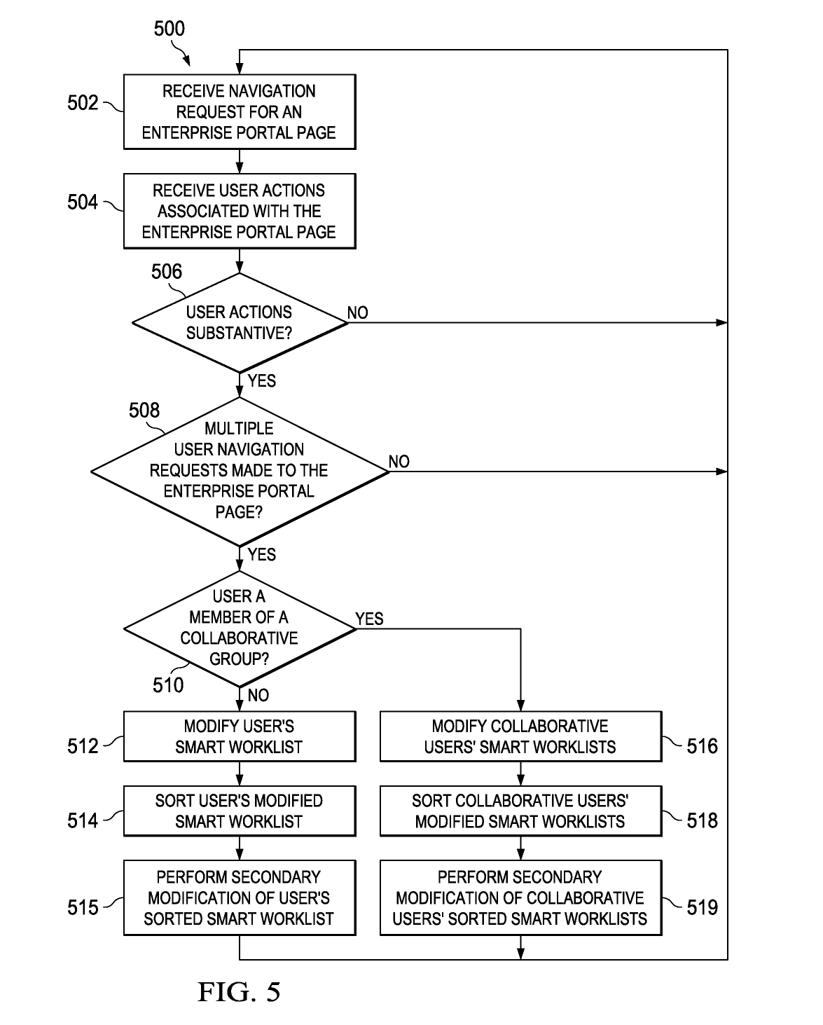

Turning now to FIG. 5, FIG. 5 is a flowchart of an example method for optimizing enterprise portal worklists. For clarity of presentation, the description that follows generally describes method 500 in the context of FIG. 1. However, it will be understood that method 500 may be performed, for example, by any other suitable system, environment, software, and hardware, or a combination of systems, environments, software, and hardware as appropriate. For example, one or more of the enterprise portal server, the client, or other computing device (not illustrated) can be used to execute method 500 and obtain any data from the memory of the client, the enterprise portal server, or the other computing device (not illustrated).

At 502, a navigation request for an enterprise portal page is received. In some implementations, the navigation request is received by the portal navigation services and forwarded to the smart worklist monitor service. In other implementations, the smart worklist monitor service receives the request independently. In some implementations, the received navigation request identifies the enterprise portal user that generated the request. From 502, method 500 proceeds to 504.

At 504, enterprise portal user's actions associated with the enterprise portal page are received. In some implementations, the action analyzer analyzes and provides the enterprise portal user's actions to the smart worklist monitor service. In some implementations, the enterprise portal user actions may be analyzed and/or received in real-time. In other implementations, the enterprise portal user's actions may be analyzed, queued, and/or cached and periodically received by the smart worklist monitor service. From 504, method 500 proceeds to 506.

At 506, a determination is made whether the received enterprise portal user's actions are substantive. In some implementations, this determination is performed by the action analyzer. In other implementations, this determination is performed by the smart worklist monitor service. In some implementations, action data may be accessed. If at 506, it is determined that the received enterprise portal user actions are substantive, as described above, method 500 proceeds to 508. If at 506, however, it is determined that the received enterprise portal user actions are not substantive, method 500 proceeds to 502.

At 508, a determination is made whether the enterprise portal user has made multiple navigation requests for the enterprise portal page the substantive actions were received from. In some implementations, this determination is performed by the action analyzer. In other implementations, this determination is performed by the smart worklist monitor service. In some implementations, action data may be accessed. If at 508, it is determined that the enterprise portal user has made multiple navigation requests to the enterprise portal page the substantive actions were received from, method 500 proceeds to 510. If at 506, however, it is determined that the enterprise portal user has not made multiple navigation requests to the enterprise portal page the substantive actions were received from, method 500 proceeds to 502.

At 510, a determination is made whether the enterprise portal user is a member of a collaborative group. In some implementations, this determination is performed by the action analyzer. In other implementations, this determination is performed by the smart worklist monitor service. In some implementations, collaborative data may be accessed. If at 510, it is determined that the enterprise portal user is a member of a collaborative group, method 500 proceeds to 516. If at 510, however, it is determined that the enterprise portal user is not a member of a collaborative group, method 500 proceeds to 512.

At 516, the collaborative users' (i.e., the enterprise portal user and the members of the collaborative group) smart worklists are modified. Modification may include adding or deleting a navigation link to the enterprise portal page in the collaborative users' smart worklists. In some implementations, all associated collaborative users associated with the enterprise portal user have their smart worklists modified. In another implementation, only a subset of the collaborative users associated with the enterprise portal user can have their smart worklists modified. In some implementations, the modification is performed by the smart worklist monitor service. From 516, method 500 proceeds to 518.

At 518, the collaborative users' modified smart worklists are sorted based upon the enterprise portal user's received actions. In some implementations, all associated collaborative users associated with the enterprise portal user have their smart worklists sorted. In another implementation, only a subset of the collaborative users associated with the enterprise portal user can have their smart worklists sorted. In some implementations, the sorting is performed by the smart worklist monitor service. From 518, method 500 proceeds to 519.

At 519, the collaborative users' sorted smart worklists are modified in a secondary manner. Secondary modification may include, for example, highlighting, truncating, increasing or decreasing font size and style, rearranging the navigation links, etc. In some implementations, all associated collaborative users associated with the enterprise portal user have their smart worklists modified in the secondary manner. In another implementation, only a subset of the collaborative users associated with the enterprise portal user can have their smart worklists modified in the secondary manner. In some implementations, the secondary modification is performed by the smart worklist monitor service. In other implementations, no secondary modifications are performed. From 519, method 500 proceeds to 502.

At 512, the enterprise portal user's smart worklist is modified. Modification may include adding or deleting a navigation link to the enterprise portal page in the collaborative users' smart worklists. In some implementations, the modification is performed by the smart worklist monitor service. From 512, method 500 proceeds to 514.

At 514, the enterprise portal user's modified smart worklist is sorted based upon the enterprise portal user's received actions. In some implementations, the sorting is performed by the smart worklist monitor service. From 514, method 500 proceeds to 515.

At 515, the enterprise portal user's sorted smart worklist is modified in a secondary manner. Secondary modification may include, for example, highlighting, truncating, increasing or decreasing font size and style, rearranging the navigation links, etc. In some implementations, the secondary modification is performed by the smart worklist monitor service. In other implementations, no secondary modifications are performed. From 515, method 500 proceeds to 502.

The preceding figures and accompanying description illustrate example processes and computer implementable techniques. But example environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the steps in these processes may take place simultaneously, concurrently, in parallel, and/or in different orders than as shown. Moreover, example environment 100 may use processes with additional steps, fewer steps, and/or different steps, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method, comprising:
receiving a navigation request by a user for an enterprise portal page associated with a navigation node view of a navigation node;
receiving at least one user action associated with the enterprise portal page;
determining, using at least one computer, whether the at least one user action is substantive;
determining whether multiple navigation requests for the enterprise portal page have been made by the user; and
determining whether the navigation request is associated with a collaborative group.

2. The computer-implemented method of claim 1, wherein the navigation request is associated with a particular computing platform.

3. The computer-implemented method of claim 1, wherein the at least one user action includes at least one of selection of a GUI component, data entry, data modification, data deletion, or generating a report.

4. The computer-implemented method of claim 1, wherein the determination of whether the at least one user action is substantive is based upon substantive determination criteria.

5. The computer-implemented method of claim 4, wherein the substantive determination criteria includes at least one of a number of navigation requests to the enterprise portal page, an enterprise portal page landing time, an interaction with the enterprise portal page, or events triggered by the user.

6. The computer-implemented method of claim 1, further comprising:
modifying a smart worklist of the user;
sorting the smart worklist of the user; and
performing a secondary modification of the smart worklist of the user.

7. The computer-implemented method of claim 1, further comprising:
modifying a smart worklist of the user and at least one collaborative user collaborating with the user as part of the collaborative group;
sorting the smart worklists of the user and the at least one collaborative user; and
performing a secondary modification the smart worklists of the user and the at least one collaborative user.

8. A computer-program product, the computer program product comprising computer-readable instructions embodied on tangible, non-transitory media, the instructions operable when executed by at least one computer to:
receive a navigation request by a user for an enterprise portal page associated with a navigation node view of a navigation node;
receive at least one user action associated with the enterprise portal page;
determine whether the at least one user action is substantive;
determine whether multiple navigation requests for the enterprise portal page have been made by the user; and
determine whether the navigation request is associated with a collaborative group.

9. The computer-program product of claim 8, wherein the navigation request is associated with a particular computing platform.

10. The computer-program product of claim 8, wherein the at least one user action includes at least one of selection of a GUI component, data entry, data modification, data deletion, or generating a report.

11. The computer-program product of claim 8, wherein the determination of whether the at least one user action is substantive is based upon substantive determination criteria.

12. The computer-program product of claim 11, wherein the substantive determination criteria includes at least one of a number of navigation requests to the enterprise portal page, an enterprise portal page landing time, an interaction with the enterprise portal page, or events triggered by the user.

13. The computer-program product of claim 8, further comprising instructions operable when executed to:
modify a smart worklist of the user;
sort the smart worklist of the user; and
perform a secondary modification of the smart worklist of the user.

14. The computer-program product of claim 8, further comprising instructions operable when executed to:
modify a smart worklist of the user and at least one collaborative user collaborating with the user as part of the collaborative group;
sort the smart worklists of the user and the at least one collaborative user; and
perform a secondary modification the smart worklists of the user and the at least one collaborative user.

15. A system, comprising:
memory operable to store at least one enterprise portal page; and
at least one hardware processor interoperably coupled to the memory and operable to perform instructions to:
receive a navigation request by a user for an enterprise portal page of the at least one enterprise portal page, the enterprise portal page associated with a navigation node view of a navigation node;
receive at least one user action associated with the enterprise portal page;
determine whether the at least one user action is substantive;
determine whether multiple navigation requests for the enterprise portal page have been made by the user; and
determine whether the navigation request is associated with a collaborative group.

16. The system of claim 15, wherein the navigation request is associated with a particular computing platform.

17. The system of claim 15, wherein the at least one user action includes at least one of selection of a GUI component, data entry, data modification, data deletion, or generating a report.

18. The system of claim 15, wherein the determination of whether the at least one user action is substantive is based upon substantive determination criteria.

19. The system of claim 18, wherein the substantive determination criteria includes at least one of a number of navigation requests to the enterprise portal page, an enterprise portal page landing time, an interaction with the enterprise portal page, or events triggered by the user.

20. The system of claim 15, further operable to perform instructions to:
modify a smart worklist of the user;
sort the smart worklist of the user; and
perform a secondary modification of the smart worklist of the user.

21. The system of claim 15, further operable to perform instructions to:
modify a smart worklist of the user and at least one collaborative user collaborating with the user as part of the collaborative group;
sort the smart worklists of the user and the at least one collaborative user; and
perform a secondary modification the smart worklists of the user and the at least one collaborative user.
